(19) United States
(12) Patent Application Publication
(10) Pub. No.: US 2007/0198295 A1
(43) Pub. Date: Aug. 23, 2007

(54) Method and system for routing information to an appropriate care provider

(76) Inventors: David Wayne Duckert, Menomonee Falls, WI (US); James Steven Cincotta, New Berlin, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/359,086

(22) Filed: Feb. 22, 2006

(51) Int. Cl. G06Q 10/00; G06F 7/00

(52) U.S. Cl. 705/2; 707/102

(57) ABSTRACT

The method and system includes efficiently routing remotely acquired patient data to both clinical and non-clinical care providers. The method and system collects a set of physiological data from the patient, accesses a set of routing rules from a routing database, and routes the set of physiological data to the appropriate care provider based on the routing rules. The method and system is configured to automatically route the set of physiological data, but may be configured for manual routing as well. The method may be embodied as software and executed on an appropriate system.

### FIELD OF THE INVENTION

The invention relates to the field of remote monitoring. More particularly, the invention relates to the field of chronic disease monitoring.

### BACKGROUND OF THE INVENTION

For a variety of reasons, monitoring of chronically ill patients in a remote, non-hospital environment will become more common in the near future. The clinical data collected, for example, blood pressure, weight, etc., is transmitted back to a caseworker or clinician who can provide early intervention to prevent re-hospitalizations. By monitoring patients remotely, costly re-hospitalization events can be avoided and the overall cost of managing the disease can be reduced.

The management of chronic care patients is often administered by a team of care providers. This team can consist of clinical care providers, such as a primary care physician, a variety of specialists (cardiologist, nephrologists, pharmacist, etc.), nurses, emergency personnel, and caseworkers. Furthermore, the team also consists of non-healthcare providers, including spouses, family, friends, neighbors, volunteer screeners and meal providers. The “team” also includes emergency personnel.

The information transmitted to or from the remote location may consist of physiologic data such as heart rate, blood pressure and weight, as well as activity data, clinical self-assessment data, compliance data and nutritional data. The information transmitted to or from the remote location may also consist of non-clinical data, including questions, educational material, compliance prompts, scheduling and environmental data. The problem is how to direct or route this information to the appropriate care provider.

For example, an extremely high blood pressure reading should get the immediate attention of the primary care provider and specialists, whereas questions about medication and general disease management can be handled by the caseworker. Issues concerning medication compliance might best be directed to family or neighbors, whereas medication side-effects should be routed to the primary care provider and specialists. Panic alarms should be routed to emergency services (911), whereas slight deviations in physiological readings should be routed to the caseworker for investigation. Positive self-assessment results for depression should be routed to a psychiatrist, whereas issues concerning diet could be directed to a caseworker or dietician. Current systems do not include such routing capabilities.

### SUMMARY OF THE INVENTION

The method and system includes efficiently routing remotely acquired patient data to both clinical and non-clinical care providers. The method and system collects a set of physiological data from the patient, accesses a set of routing rules from a routing database, and routes the set of physiological data to the appropriate care provider based on the routing rules. The method and system is configured to automatically route the set of physiological data, but may be configured for manual routing as well. The method may be embodied as software and executed on an appropriate system.

In one aspect of the invention, a method of routing medical information comprises collecting a set of remote patient data from a patient, accessing a set of routing rules in a routing database and routing the set of remote patient data to a first caregiver in accordance with the routing rules, or routing the set of remote patient data to a second caregiver when the first caregiver is not able to appropriately respond to the patient and the first caregiver adding notations to the remote patient data, re-accessing the set of routing rules in the routing database in order to re-route the set of remote patient data to a second caregiver in accordance with the routing rules. The method further comprises entering the set of routing rules into the routing database, wherein the routing rules include a set of patient characteristics, and further wherein the entering step includes entering a set of physician protocols, entering a set of physician rules, and entering a patient medical file. The method further comprises classifying a plurality of caregivers including the first caregiver as one of including an emergency caregiver, a clinical caregiver, and a support caregiver and wherein the routing step is effectuated automatically without assistance from an operator or the routing step is effectuated manually by an operator having access to the set of routing rules in the routing database.

In another aspect of the invention, a system for routing medical information comprises a remote sensing system configured to collect a set of remote patient data from a patient, a storage media for storing a computer application, and a processing unit coupled to the remote sensing system and the storage media, and configured to execute the computer application, and further configured to receive the set of patient data from the remote sensing system, wherein when the computer application is executed, a routing database having a set of routing rules is accessed, and further wherein the set of remote patient data is routed to a first caregiver in accordance with the routing rules. When the first caregiver is not able to appropriately respond, the set of remote patient data is routed to second caregiver. The first caregiver adds notations to the remote patient data and re-assesses the set of routing rules in the routing database in order to re-route the set of remote patient data to a second caregiver in accordance with the routing rules. The set of routing rules are entered into the routing database, wherein the routing rules include a set of patient characteristics, and further wherein the routing rules include a set of physician protocols, a set of physician rules, and a patient medical file. The system further comprising a plurality of caregivers including the first caregiver, wherein each of the plurality of caregivers is classified as one of the including an emergency caregiver, a clinical caregiver, and a support caregiver. The system wherein the set of remote patient data is routed automatically without assistance from an operator or the set of remote patient data is routed manually by an operator having access to the set of routing rules in the routing database.

### BRIEF DESCRIPTION OF THE DRAWINGS

FIG. 1 illustrates a flow chart of a method in accordance with an embodiment of the present invention.

FIG. 2 illustrates a block diagram of a method in accordance with an embodiment of the present invention.

FIG. 3 illustrates a block diagram of a system in accordance with an embodiment of the present invention.

### DETAILED DESCRIPTION OF THE INVENTION

The invention is a system and method preferably implemented in a software application that routes information from a remote location to an appropriate care provider. The routing is either automatic or manual, wherein the automatic routing is based on a collection of rules. The rules consider the nature of the information, the acuity level of the information, the history of the patient, the structure of the caregiver network, and other factors.

For example, it may be suspected, by means of physiological data collection, that a patient is not compliant with their prescribed medication regimen. First level action is routed to non-clinical screeners who contact the patient over the telephone to learn the reason for non-compliance: “Good afternoon Mrs. Smith, I noticed your blood pressure is higher than usual over the last few days, are you still taking your blood pressure medication?” If the reason is logistical in nature; in other words, couldn't get a refill, lost the bottle, etc., the screener can route the issue to the caseworker who might be able to expedite and deliver a refill. If the reason is clinical in nature, in other words, the side effects are too severe, etc., the issue and data may be routed to the primary care physician who can moderate the dosage or try another medication. If the reason was simply forgetfulness, the issue could be routed to family or neighbors, who might be able to intervene. If the issue is psycho-social in nature; the issue can be routed to a psychiatrist.

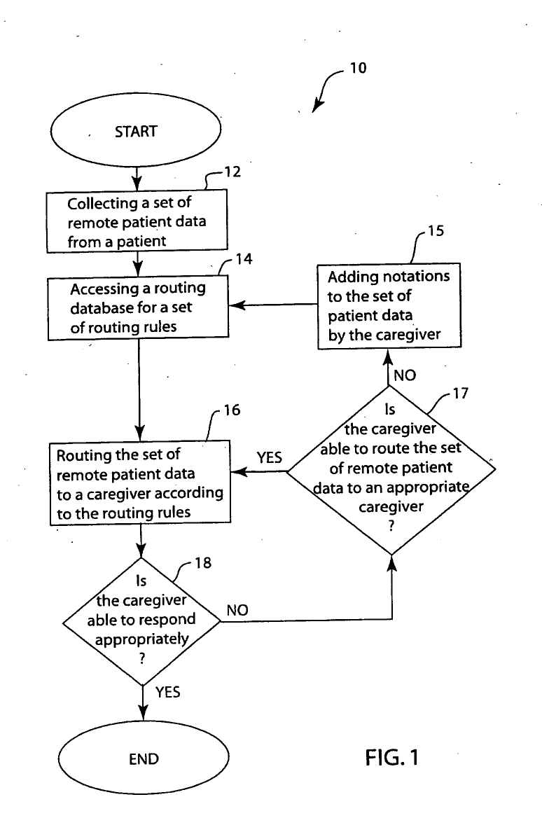

FIG. 1 illustrates a routing method 10 for routing information to an appropriate care provider. In step 12, a set of remote patient data is collected from a patient. Preferably, the patient data is collected by an in-home monitoring system, as is known in the art. However, it is has been contemplated that the remote patient data can be collected by any remote patient monitoring device such as a mobile device, or even a hospital monitoring system. In step 14, a routing database is accessed for a set of routing rules. Preferably, the routing database is accessed automatically by a computer software program executing this method. In alternative embodiments, the routing database may be accessed by an individual manually assigned to do so. Likewise, in step 16, the set of remote patient data is routed to a caregiver according to the routing rules. Again, it is preferred that the set of remote patient is routed automatically, but the routing may also be carried out by an individual operating a routing terminal.

After the patient data is routed to a caregiver, the caregiver indicates whether he or she is able to respond appropriately to the remote patient data. In decision box 18, if the caregiver is able to respond appropriately, then the method ends. However, if the caregiver is not able to respond appropriately then in decision box 17 it is determined whether the caregiver is able to route the set of remote patient data to an appropriate caregiver. The answer to this question will be determined by whether the caregiver knows who the appropriate caregiver might be, and further whether the caregiver knows how to contact this appropriate caregiver. If the caregiver is able to route the remote patient data to this appropriate caregiver, then the method continues back to step 16. However if the caregiver is not able to route the set of remote patient data to the appropriate caregiver, then the caregiver adds notations to the set of patient data in step 15 and the method continues onto step 14, wherein the routing database is accessed again, but now taking into consideration the additional notations from the caregiver in step 15.

It should also be noted that the set of routing rules and a set of patient characteristics are to be entered into the routing database at some point prior to step 14. The database is prepared which such information from physician protocol manuals, by collecting the rules manually from physicians, and collecting information from patient files. The routing database may be updated with new or amended routing rules, and/or updated patient characteristics at any time.

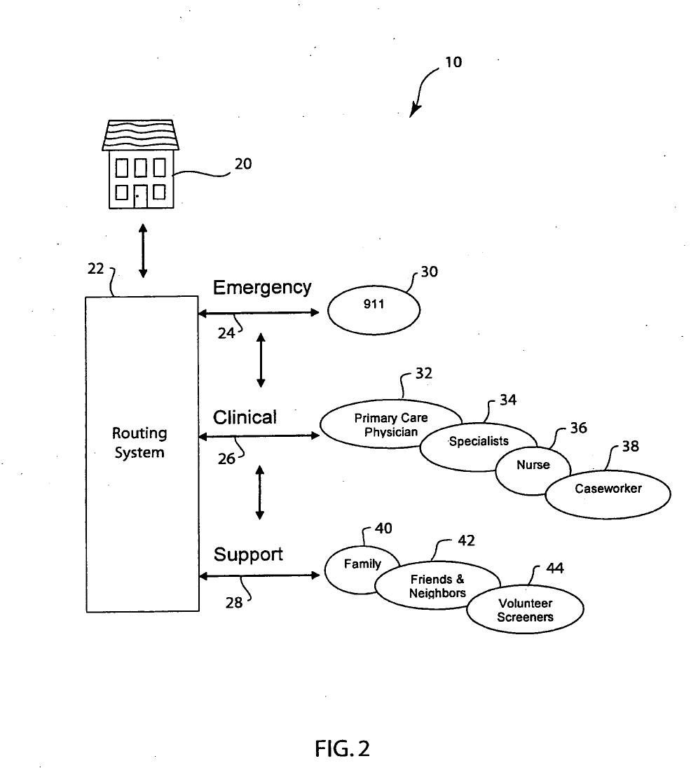

FIG. 2 illustrates a block diagram of the routing method 10. Here a patient has remote patient data collected in a home environment 20 and the information is relayed to the routing system 22. Utilizing the routing rules from the routing database, the routing system 22 may classify the remote patient data as intended for emergency caregivers 24, clinical caregivers 26, or support caregivers 28. Examples of each type of caregiver is also depicted in FIG. 2, including a 911 operator 30 as an emergency caregiver 24, a primary care physican 32, a specialist 34, a nurse 36 or careworker 38, as clinical caregivers 26, and family 40, friends and neighbors 42, or volunteer screeners 44 as support caregivers 28 it should be noticed that these examples of caregivers are not exhaustive, and further the classifications of emergency, clinical 26, and support 28 given to the caregivers are not the only set of classifications. The system and method may be modified to include additional caregivers, as well as additional classifications of such caregivers.

Still referring to FIG. 2, as stated previously, once the routing system determines a caregiver to route the set of remote patient data 22, the remote patient data is routed to that caregiver where it is determined that caregiver is able to respond to the remote patient data. As an example, the patient in the home environment 20 may develop an elevated heart rate. This piece of remote patient data would be relayed to the routing system, and according to routing rules, may be routed to a support caregiver 28 such as a volunteer screener 44. The volunteer screener 44, realizing that an elevated heartbeat is a condition out of the realm of his or her expertise may either route this remote patient data to a clinical caregiver 26, such as a nurse 36 or a primary care physician 32, or may route the remote patient data back to the routing system 22. The volunteer screeners 44 ability to route the remote patient data to another caregiver is depicted by the two-way arrows between the clinical caregiver 26 and the support caregiver 28. Likewise, the volunteer screener's 44 ability to route the remote patient data back to the routing system 22 is depicted by the two-way arrow associated with the support caregiver 28. The two-way arrows associated with each of the emergency caregivers 24, clinical caregivers 26 and support caregivers 28 also indicates the ability of any caregiver to respond appropriately to the remote patient data back to the routing system 22 and further to the patient in the home environment 20. If the caregiver routes the remote patient data back to the routing system 22, the caregiver will either add notations to the remote patient data so that the routing system 22, applying the routing rules to the data with notations, will re-route the data to the appropriate caregiver, or the routing system will be able to recognize that the data needs to be routed to a more specialized caregiver based on the mere face that the data was sent back to the routing system 22.

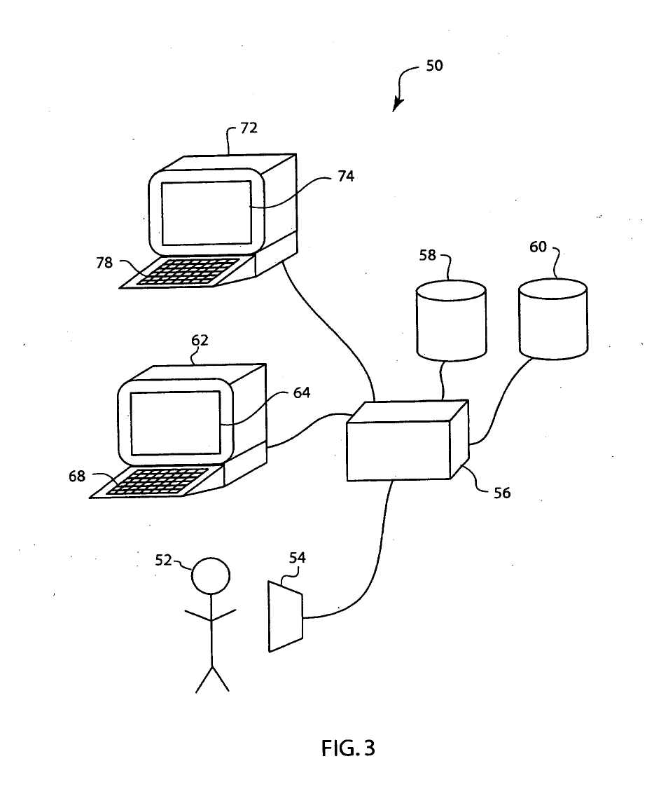

It should be understood that the method may be implemented as software and executed on an appropriate routing system 50 including a storage medium, a processor, an electronic device such as a computer, laptop, PDA, or other similar device, and be compatible with the remote sensing system as well as the appropriate databases. FIG. 3 illustrates an embodiment of this routing system 50. Referring to FIG. 3, the computer code embodying the software is stored in the storage media 58. The remote sensing system 54 collects the remote patient data from the patient 52, and the processor 56, executing the computer code, utilizes the routing rules in the database 60 to route the remote patient data to the appropriate caregiver terminal 72.

Still referring to FIG. 3, the caregiver terminal 72 includes a graphical user interface 74 and an input device 78. In FIG. 3, the caregiver terminal 72 is depicted as a personal type computer. However it is recognized that in other embodiments, the caregiver may be notified of remote patient data through a PDA, a pager, a simple alarm, or any other method known in the art. The routing system 50 also includes a routing terminal 62, including a routing user graphical interface 64 and a routing input device 68. This routing terminal 62, included in alternative embodiments, is present in the routing system 50 in order to manually route remote patient data to an appropriate caregiver terminal 72. It should also be noted that the caregiver terminal 72 illustrates just one caregiver's ability to receive remote patient data. In a preferred system 50, there are multiple caregiver terminals 72 as there are multiple caregivers. As stated above, it is not required that each caregiver have a caregiver terminal 72 including a personal computer, as depicted in FIG. 3. More importantly, each caregiver terminal 72 is coupled to the processor 56, and may be further coupled to one another via the internet or some other network, such that each caregiver may route the remote patient data to another caregiver, or back to the processor 56 as was discussed in the method 10 in FIG. 1.

There are many advantages associated with this routing method and system. This routing method and system will direct data to the appropriate sources, thereby improving the efficiency of the caregiver network. Furthermore, this system and method routes remotely gathered information to both clinical and non-clinical care providers, including non-clinical care providers such as family, friends and volunteer screeners.

The present invention has been described in terms specific embodiments incorporating details to facilitate the understanding the principles of construction and operation of the invention. Such reference herein to specific embodiments and details thereof is not intended to limit scope of the claims appended hereto. It will be apparent to those skilled in the art that modifications may be made in the embodiment chosen for illustration without departing from the spirited scope of the invention.

We claim:

1. A method of routing medical information, the method comprising:
collecting a set of remote patient data from a patient;
accessing a set of routing rules in a routing database; and
routing the set of remote patient data to a first caregiver in accordance with the routing rules.

2. The method as claimed in claim 1, further comprising routing the set of remote patient data to a second caregiver when the first caregiver is not able to appropriately respond to the patient.

3. The method as claimed in claim 1, further comprising the first caregiver adding notations to the remote patient data, re-accessing the set of routing rules in the routing database in order to re-route the set of remote patient data to a second caregiver in accordance with the routing rules.

4. The method as claimed in claim 1, further comprising entering the set of routing rules into the routing database, wherein the routing rules include a set of patient characteristics, and further wherein the entering step includes:
entering a set of physician protocols;
entering a set of physician rules; and
entering a patient medical file.

5. The method as claimed in claim 1, further comprising classifying a plurality of caregivers including the first caregiver as one of including:
an emergency caregiver;
a clinical caregiver; and
a support caregiver.

6. The method as claimed in claim 1, wherein the routing step is effectuated automatically without assistance from an operator.

7. The method as claimed in claim 1, wherein the routing step is effectuated manually by an operator having access to the set of routing rules in the routing database.

8. A system for routing medical information, the system comprising:
a remote sensing system configured to collect a set of remote patient data from a patient;
a storage media for storing a computer application; and
a processing unit coupled to the remote sensing system and the storage media, and configured to execute the computer application, and further configured to receive the set of patient data from the remote sensing system,
wherein when the computer application is executed, a routing database having a set of routing rules is accessed, and further wherein the set of remote patient data is routed to a first caregiver in accordance with the routing rules.

9. The system as claimed in claim 8, wherein when the first caregiver is not able to appropriately respond, the set of remote patient data is routed to second caregiver.

10. The system as claimed in claim 8, wherein the first caregiver adds notations to the remote patient data and re-assesses the set of routing rules in the routing database in order to re-route the set of remote patient data to a second caregiver in accordance with the routing rules.

11. The system as claimed in claim 8, wherein the set of routing rules are entered into the routing database, wherein the routing rules include a set of patient characteristics, and further wherein the routing rules include:
a set of physician protocols;
a set of physician rules; and
a patient medical file.

12. The system as claimed in claim 8, further comprising a plurality of caregivers including the first caregiver, wherein each of the plurality of caregivers is classified as one of the including:
an emergency caregiver;
a clinical caregiver; and
a support caregiver.

13. The system as claimed in claim 8, wherein the set of remote patient data is routed automatically without assistance from an operator.

14. The system as claimed in claim 8, wherein the set of remote patient data is routed manually by an operator having access to the set of routing rules in the routing database.

15. A method of routing medical information of a patient to an appropriate caregiver, the method comprising:
entering a set of routing rules into a routing database, wherein the routing rules include a set of patient characteristics;
collecting a set of remote patient data from the patient;
accessing the set of touring rules in the routing database;
automatically routing the set of remote patient data to a first caregiver in accordance with the routing rules; and
routing the set of remote patient data to a second caregiver when the first caregiver is not able to appropriately respond to the patient.
